(19) United States
(12) Patent Application Publication
(10) Pub. No.: US 2022/0336807 A1
(43) Pub. Date: Oct. 20, 2022

(54) SOLID-STATE BATTERY

(71) Applicant: Murata Manufacturing Co., Ltd., Nagaokakyo-shi (JP)

(72) Inventors: Ryohei TAKANO, Nagaokakyo-shi (JP); Makoto YOSHIOKA, Nagaokakyo-shi (JP); Takeo ISHIKURA, Nagaokakyo-shi (JP); Akisuke ITO, Nagaokakyo-shi (JP)

(21) Appl. No.: 17/857,378

(22) Filed: Jul. 5, 2022

Related U.S. Application Data
(63) Continuation of application No. PCT/JP2021/000719, filed on Jan. 12, 2021.

(30) Foreign Application Priority Data
Jan. 16, 2020 (JP) 2020-005426

(51) Int. Cl. H01M 4/525; H01M 10/0562

(52) U.S. Cl. CPC H01M 4/525; H01M 10/0562; H01M 2004/028

(57) ABSTRACT

A solid-state battery including a positive electrode layer that includes a positive electrode active material having a layered rock salt-type structure and including a Li transition metal oxide containing at least one element selected from the group consisting of Co, Ni and Mn, and a solid electrolyte having a LISICON-type structure; and the positive electrode active material has an average particle size of 4 μm or less.

### CROSS REFERENCE TO RELATED APPLICATIONS

The present application is a continuation of International application No. PCT/JP2021/000719, filed Jan. 12, 2021, which claims priority to Japanese Patent Application No. 2020-005426, filed Jan. 16, 2020, the entire contents of each of which are incorporated herein by reference.

### FIELD OF THE INVENTION

The present invention relates to a solid-state battery.

### BACKGROUND OF THE INVENTION

In recent years, a demand for batteries as power sources for portable type electronic devices such as mobile phones and portable type personal computers has greatly expanded. In batteries used for such applications, an electrolyte (electrolytic solution) such as an organic solvent has conventionally been used as a medium for moving ions.

However, in the battery having the above configuration, there is a risk that the electrolytic solution leaks, moreover, there is a problem that the organic solvent or the like used for the electrolytic solution is a combustible substance. Therefore, the use of a solid electrolyte instead of the electrolytic solution has been proposed. In addition, a development of a sintered-type solid secondary battery in which a solid electrolyte is used as an electrolyte and other constituent elements are also composed of a solid has been advanced.

In the field of such a solid-state battery, a solid-state battery including an oxide having a LISICON-type crystal structure as a solid electrolyte is known (Non-Patent Documents 1 and 2). In addition, a solid-state battery including an oxide having a layered rock salt-type crystal structure as a positive electrode active material is known (Non-Patent Document 3).

Non-Patent Document 1: P. G. Bruce et. al., J. solid state chem., 44 (1982), 354-365.

Non-Patent Document 2: Okumura et al., Proceedings of The 59th Battery Symposium, 2018 (2018), 3A-19, 60.

Non-Patent Document 3: D. Wang et. al., Appl. Mater. Interfaces, 11 (2019) 4954-4961.

### SUMMARY OF THE INVENTION

However, in the conventional solid-state battery, a problem of deteriorating of cycle characteristics caused by charging and discharging arose. When the cycle characteristics deteriorated, a discharge capacitance of the solid-state battery was gradually reduced due to a repetition of charging and discharging, and the solid-state battery could not withstand its repeated use.

As a result of studies by the inventors, they have found that the cycle characteristics can be remarkably improved by controlling the particle size of the positive electrode active material in a solid-state battery having a positive electrode layer including a solid electrolyte having the LISICON-type structure and a positive electrode active material having a layered rock salt-type structure.

An object of the present invention is to provide a solid-state battery having more excellent cycle characteristics.

The present invention relates to a solid-state battery including a positive electrode layer, in which the positive electrode layer includes a positive electrode active material having a layered rock salt-type structure and including a Li transition metal oxide containing at least one element selected from the group consisting of Co, Ni, and Mn and a solid electrolyte having the LISICON-type structure, and the positive electrode active material has an average particle size of 4 μm or less.

A solid-state battery of the present invention is more excellent in cycle characteristics.

### BRIEF EXPLANATION OF THE DRAWINGS

FIG. 1 shows a charge/discharge curve of a solid-state battery of Example 4 during 10 cycles.

FIG. 2 shows a charge/discharge curve of a solid-state battery of Example 11 during 10 cycles.

FIG. 3 shows a charge/discharge curve of a solid-state battery of Comparative Example 2 during 10 cycles.

### DETAILED DESCRIPTION OF THE INVENTION

[Solid-State Battery]

The present invention provides to a solid-state battery. The term “solid-state battery” as used herein refers to a battery in which constituent elements thereof (particularly, electrolyte layers) are composed of a solid in a broad sense, and refers to an “all-solid-state battery” in which constituent elements thereof (particularly, all constituent elements) are composed of a solid in a narrow sense. The term “solid-state battery” as used herein includes a so-called “secondary battery” that can be repeatedly charged and discharged, and a “primary battery” that can only be discharged. The “solid-state battery” is preferably a “secondary battery”. The “secondary battery” is not excessively limited by its name, and can also include, for example, an electrochemical device such as a “power storage device”.

The solid-state battery of the present invention includes a positive electrode layer, and usually has a laminated structure in which a positive electrode layer and a negative electrode layer are laminated with a solid electrolyte layer interposed therebetween. Each of the positive electrode layer and the negative electrode layer may be laminated with two or more layers as long as a solid electrolyte layer is provided therebetween. The solid electrolyte layer is in contact with the positive electrode layer and the negative electrode layer and sandwiched therebetween. The positive electrode layer and the solid electrolyte layer are integrally sintered among sintered bodies and/or the negative electrode layer and the solid electrolyte layer may be integrally sintered among the sintered bodies. Integrally sintering among the sintered bodies means that two or more members (particularly, layers) adjacent to or in contact with each other are joined by sintering. Here, the two or more members (particularly, layers) may be integrally sintered while being all the sintered bodies.

(Positive Electrode Layer)

The positive electrode layer includes a positive electrode active material and a solid electrolyte. In the positive electrode layer, both the positive electrode active material and the solid electrolyte preferably have a form of a sintered body. For example, the positive electrode layer preferably has a form of a sintered body in which the positive electrode active material particles are bonded to each other by the solid electrolyte, and the positive electrode active material particles, and the positive electrode active material particles and the solid electrolyte are mutually joined by sintering.

The positive electrode active material has the layered rock salt-type structure and includes a Li transition metal oxide (hereinafter, sometimes referred to as “metal oxide A”) containing at least one element selected from the group consisting of Co, Ni, and Mn. Thereby, a side reaction between the positive electrode active material and the solid electrolyte during co-sintering can be suppressed. The metal oxide A is usually included in a form of particles (particularly, sintered body grains) in the positive electrode layer. The content ratio of the metal oxide A to the whole positive electrode active material of the positive electrode layer is not particularly limited, and is preferably 50 mass % or more, more preferably 70 mass % or more, still more preferably 90 mass % or more, and most preferably 100 mass % from the viewpoint of further improving the cycle characteristics. When the positive electrode active material includes no metal oxide A, the side reaction between the positive electrode active material and the solid electrolyte during co-sintering cannot be suppressed, and therefore a sufficient discharge capacitance cannot be obtained from the first time.

The fact that the metal oxide A has the layered rock salt-type structure means that the oxide (particularly, particles thereof) has a layered rock salt-type crystal structure, and in a broad sense, it means that the metal oxide A has a crystal structure that can be recognized as a layered rock salt-type crystal structure by those skilled in the art of the solid-state battery. In a narrow sense, the fact that the metal oxide A has the layered rock salt-type structure means that the oxide (particularly, particles thereof) shows one or more main peaks corresponding to a Miller index inherent to a so-called layered rock salt-type crystal structure at a predetermined incident angle in X-ray diffraction.

The metal oxide A is preferably a positive electrode active material that at least exhibits a volume expansion during charging (that is, when Li is extracted from the crystal structure before charging)(for example, at an initial stage of charging) as compared to a volume thereof before charging. The positive electrode active material exhibiting the volume change as described above is used, thereby breakdown of the solid electrolyte in the positive electrode layer is suppressed and high cyclability can be obtained as compared with the case of using the electrode active material that contracts during charging. From the above viewpoint, the compound is preferably a compound having a chemical composition containing at least Co, and more preferably a compound having a chemical composition containing at least Co and having a molar ratio of Co to Li (Co/Li) of 0.5 to 2.0 and particularly 0.8 to 1.5. The metal oxide A has such a composition, thereby an active material including a process of expanding during charging can be produced. In addition, the reactivity with the LISICON-type solid electrolyte can be further reduced, and further improvement in cycle characteristics can be achieved. At this time, as the metal oxide A, one obtained by appropriately substituting the Li site or the Co site of LiCoO₂ with an element may be used. Examples of the substituting element include one or more elements selected from the group consisting of Mg, Al, Ni, and Mn. In addition, in a compound that expands during charging (for example, at an initial stage of charging), an active material that contracts at an end stage of charging as compared to the volume of the active material before charging depending on an amount of Li extracted, is also present. In order to obtain a maximum effect of the present invention, charging is preferably performed within a range in which the volume of the active material does not become smaller than that before charging.

Specific examples of the metal oxide A include LiCoO₂, Li(Co_{0.95}Mg_{0.05})O₂, Li(Co_{0.95}Al_{0.05})O₂, Li(Co_{0.6}Ni_{0.2}Mn_{0.2})O₂, Li(Co_{0.6}Ni_{0.1}Mn_{0.3})O₂, Li(Co_{0.8}Ni_{0.1}Mn_{0.1})O₂, Li(Co_{0.95}Al_{0.05})O₂, Li(Co_{0.6}Ni_{0.2}Mn_{0.2})O₂, Li(Co_{0.8}Ni_{0.1}Mn_{0.1})O₂, Li(Co_{1/3}Ni_{1/3}Mn_{1/3})O₂, Li(Ni_{0.8}Co_{0.15}Al_{0.05})O₂, and Li(Co_{0.4}Ni_{0.3}Mn_{0.3})O₂. Among those, LiCoO₂, Li(Co_{0.95}Mg_{0.05})O₂, Li(Co_{0.95}Al_{0.05})O₂, Li(Co_{0.6}Ni_{0.2}Mn_{0.2})O₂, Li(Co_{0.6}Ni_{0.1}Mn_{0.3})O₂, and Li(Co_{0.8}Ni_{0.1}Mn_{0.1})O₂ are particularly preferably used from the viewpoint of further improving the cycle characteristics based on further reduction of the volume change during charging.

The chemical composition of the positive electrode active material may be an average chemical composition. The average chemical composition of the positive electrode active material means an average value of the chemical composition of the positive electrode active material in a thickness direction of the positive electrode layer. The average chemical composition of the positive electrode active material can be analyzed and measured by breaking the solid-state battery and performing composition analysis by EDX using SEM-EDX (energy dispersive X-ray spectroscopy) in a field of view which fits the whole thickness direction of the positive electrode layer.

In the positive electrode layer, the average chemical composition of the positive electrode active material and the average chemical composition of the solid electrolyte described later can be automatically distinguished and measured according to their compositions in the composition analysis described above.

The positive electrode active material can be manufactured, for example, by the following method. First, a raw material compound containing a predetermined metal atom is weighed so that the chemical composition have a predetermined chemical composition, and water is added thereto and mixed to obtain a slurry. The slurry is dried, calcined at 700° C. or higher and 1000° C. or lower for 1 hour or longer and 30 hours or shorter, and pulverized to be able to obtain a positive electrode active material.

The chemical composition and the crystal structure of the positive electrode active material in the positive electrode layer may be usually changed by element diffusion during sintering in a manufacturing process of the solid-state battery. The positive electrode active material preferably has the average chemical composition and the crystal structure described above in the solid-state battery after being sintered together with the negative electrode layer and the solid electrolyte layer.

The average particle size of the positive electrode active material is 4 μm or less (particularly, 0.01 μm to 4 μm), and from the viewpoint of further improving the cycle characteristics, the average particle size thereof is preferably 2.5 μm or less (particularly, 0.04 μm to 2.5 μm) (hereinafter, sometimes referred to as “range A1”), more preferably 0.07 μm to 1.0 μm (hereinafter, sometimes referred to as “range A2”), and still more preferably 0.1 μm to 0.5 μm (hereinafter, sometimes referred to as “range A3”).

In the present invention, in the solid-state battery including the solid electrolyte having the LISICON-type structure described later, the average particle size of the positive electrode active material is set within the above range, thereby peeling between the positive electrode active material and the solid electrolyte can be suppressed, and the cycle characteristics can be greatly improved. The reason for this is not necessarily clear, but this is considered to be based on the following reasons (1) and (2):

(1) the particle size of the positive electrode active material is reduced, thereby stress generated in the positive electrode layer due to volume expansion and contraction can be dispersed; and

(2) with a reduction in the particle size of the positive electrode active material, a contact area at an interface between the positive electrode active material and the solid electrolyte per unit volume increases, thereby the adhesive strength between the positive electrode active material particles and the solid electrolyte increases.

In the solid-state battery, in the positive electrode layer in which the average particle size of the positive electrode active material is too large, peeling between the positive electrode active material and the solid electrolyte or cracking in the positive electrode layer progresses due to a volume expansion of the positive electrode active material caused by charging and discharging. As a result, the cycle characteristics of the solid-state battery remarkably deteriorate.

As described above, the particle size of the positive electrode active material is preferably set to the range A1, more preferably to the range A2, and still more preferably to the range A3, thereby more excellent cycle characteristics can be obtained. The particle size is set as described above, thereby not only peeling between the positive electrode active material and the solid electrolyte but also cracking in the positive electrode active material and/or the solid electrolyte can be further suppressed, and therefore more excellent cycle characteristics can be obtained.

When the lower limit value of the average particle size of the positive electrode active material is less than 0.01 μm, the cycle characteristics deteriorate again. This is considered to be because when the particle size of the positive electrode active material becomes too small, the activity on the surface of the positive electrode active material increases, thereby the side reaction easily occurs at the interface between the positive electrode active material and the solid electrolyte. From the viewpoint of further improving the cycle characteristics based on prevention of such the side reaction, the average particle size of the positive electrode active material is preferably 0.04 μm or more, more preferably 0.07 μm or more, and still more preferably 0.1 μm or more.

The optimum particle size range of the positive electrode active material greatly changes according to the type (particularly, crystal structure) of the positive electrode active material and the solid electrolyte. This is considered to be because the breaking strength of the positive electrode active material and solid electrolyte themselves, the adhesive strength and reactivity between the positive electrode active material and the solid electrolyte, and the like change according to the type (particularly, crystal structure) of the positive electrode active material and the solid electrolyte. The above-described range of the average particle size of the positive electrode active material is particularly effective in a combination of the positive electrode active material having the layered rock salt-type structure and the solid electrolyte having the LISICON-type structure.

As to the average particle size of the positive electrode active material, for example, 10 to 100 particles are randomly selected from a SEM image, and the particle sizes thereof can be simply averaged to determine the average particle size (arithmetic average).

The particle size is a diameter of a spherical-shaped particle when the particle is assumed to be perfect spherical. For such a particle size, for example, a surface of section of the solid-state battery is cut out, a sectional SEM image is photographed using an SEM, a sectional area S of the particle is calculated using image analysis software (for example, “A image-kun” (manufactured by Asahi Kasei Engineering Corporation)), and then a particle diameter R can be determined by the following mathematical formula 1:

R=2×(S/π)^{1/2}

Note that the average particle size of the positive electrode active material in the positive electrode layer can be automatically measured by specifying the positive electrode active material according to the composition at the time of measuring the average chemical composition described above.

The average particle size of the positive electrode active material in the positive electrode layer may usually change due to sintering in the manufacturing process of the solid-state battery. The positive electrode active material preferably has the above-described average particle size in the solid-state battery after being sintered together with the negative electrode layer and the solid electrolyte layer.

The volume ratio of the positive electrode active material in the positive electrode layer is not particularly limited, and is preferably 20% to 90%, more preferably 40% to 80%, and still more preferably 40% to 70% from the viewpoint of the balance between further improvement in cycle characteristics and high energy density of the solid-state battery.

The volume ratio of the positive electrode active material in the positive electrode layer can be measured by SEM-EDX analysis after FIB sectional processing. For details, a site where the molar ratio of the elements (Co, Ni, and Mn) constituting the positive electrode active material is larger than the molar ratio of the elements constituting the solid electrolyte from EDX is determined as the positive electrode active material to calculate the area ratio of the site, thereby the measurement can be performed.

The particle shape of the positive electrode active material in the positive electrode layer is not particularly limited as long as the average particle size is within the above range, and may be, for example, any particle shape of a spherical shape, a flat shape, and an irregular shape.

The positive electrode layer further includes a solid electrolyte having the LISICON-type structure. The LISICON-type structure of the solid electrolyte in the positive electrode layer includes a β_{I}-type structure, a β_{II}-type structure, a β_{II}′-type structure, a T_{I}-type structure, a T_{II}-type structure, a γ_{II}-type structure, and a γ₀-type structure. That is, the positive electrode layer may include one or more solid electrolytes having a β_{I}-type structure, a β_{II}-type structure, a β_{II}′-type structure, a T_{I}-type structure, a T₁₁-type structure, a γ_{II}-type structure, a γ₀-type structure, or a composite structure thereof. The LISICON-type structure of the solid electrolyte in the positive electrode layer is preferably a γ_{II}-type structure from the viewpoint of further reducing the recycling characteristics.

The fact that the solid electrolyte has a γ_{II}-type structure in the positive electrode layer means that the solid electrolyte has a γ_{II}-type crystal structure, and in a broad sense, it means that the solid electrolyte has a crystal structure that can be recognized as a γ_{II}-type crystal structure by those skilled in the art of the solid-state battery. In a narrow sense, the fact that the solid electrolyte has a γ_{II}-type structure in the positive electrode layer means that the solid electrolyte shows one or more main peaks corresponding to a Miller index inherent to a so-called γ_{II}-Li₃VO₄-type crystal structure at a predetermined incident angle in X-ray diffraction. A compound having a γ_{II}-type structure (that is, a solid electrolyte) is described, for example, in the document “J. solid state chem” (A. R. West et. al, J. solid state chem., 4, 20-28 (1972)), and an example thereof includes ICDD Card No. 01-073-2850.

The fact that the solid electrolyte has a β_{I}-type structure in the positive electrode layer means that the solid electrolyte has a β_{I}-type crystal structure, and in a broad sense, it means that the solid electrolyte has a crystal structure that can be recognized as a β_{I}-type crystal structure by those skilled in the art of the solid-state battery. In a narrow sense, the fact that the solid electrolyte has a β_{I}-type structure in the positive electrode layer means that the solid electrolyte shows one or more main peaks corresponding to a Miller index inherent to a so-called β_{I}-Li₃VO₄-type crystal structure at a predetermined incident angle in X-ray diffraction. A compound having a β_{I}-type structure (that is, a solid electrolyte) is described, for example, in the document “J. solid state chem” (A. R. West et. al, J. solid state chem., 4, 20-28 (1972)), and as an example thereof, for example, XRD data (the d-values of the interplanar distance and the Miller indices corresponding thereto) described in the following table is shown.

TABLE 1

Li [symbol] CoSiO [symbol]
βt, 25 ° C.

| d(Å) | I | h k l |
|---|---|---|
| 5.4 | 80 | 1 1 0 |
| 4.08 | 60 | 1 2 0 |
| 3.88 | 60 | 1 0 1 |
| 3.65 | 100 | 1 1 1, 0 2 1 |
| 3.14 | 20 | 2 0 0, 1 2 1 |
| 3.10 | 40 | 1 3 0 |
| 2.71 | 80 | 2 2 0 |
| 2.68 | 60 | 0 4 0 |
| 2.47 | 80 | 0 0 2 |
| 2.38 | 60 | 2 2 1 |
| 2.36 | 20 | 0 4 1 |

[symbol]

indicates data missing or illegible when filed

The fact that the solid electrolyte has a β_{II}-type structure in the positive electrode layer means that the solid electrolyte has a β_{II}-type crystal structure, and in a broad sense, it means that the solid electrolyte has a crystal structure that can be recognized as a β_{II}-type crystal structure by those skilled in the art of the solid-state battery. In a narrow sense, the fact that the solid electrolyte has a β_{II}-type structure in the positive electrode layer means that the solid electrolyte shows one or more main peaks corresponding to a Miller index inherent to a so-called β_{II}-Li3VO₄-type crystal structure at a predetermined incident angle in X-ray diffraction. A compound having a β_{II}-type structure (that is, a solid electrolyte) is described, for example, in the document “J. solid state chem” (A. R. West et. al, J. solid state chem., 4, 20-28 (1972)), and an example thereof includes ICDD Card No. 00-024-0675.

The fact that the solid electrolyte has a β_{II}′-type structure in the positive electrode layer means that the solid electrolyte has a β_{II}′-type crystal structure, and in a broad sense, it means that the solid electrolyte has a crystal structure that can be recognized as a β_{II}′-type crystal structure by those skilled in the art of the solid-state battery. In a narrow sense, the fact that the solid electrolyte has a β_{II}′-type structure in the positive electrode layer means that the solid electrolyte shows one or more main peaks corresponding to a Miller index inherent to a so-called β_{II}′-Li₃VO₄-type crystal structure at a predetermined incident angle in X-ray diffraction. A compound having a β_{II}′-type structure (that is, a solid electrolyte) is described, for example, in the document “J. solid state chem” (A. R. West et. al, J. solid state chem., 4, 20-28 (1972)), and as an example thereof, for example, XRD data (the d-values of the interplanar distance and the Miller indices corresponding thereto) described in the following table is shown.

TABLE 2

Li [symbol] CoGeO [symbol]
β [symbol] , 25° C.

| d(Å) | I | h k l |
|---|---|---|
| | | 0 1 0 |
| 4.17 | 80 | 1 1 0 |
| 3.96 | 80 | 1 0 1 |
| 3.70 | 10 | 0 1 1 |
| 3.20 | 20 | 2 0 0, 1 1 1 |
| 2.75 | 100 | 2 1 0 |
| 2.74 | 60 | 0 2 0 |
| 2.50 | 80 | 0 0 2 |
| | | 1 2 0 |

[symbol]

indicates data missing or illegible when filed

The fact that the solid electrolyte has a T_{I}-type structure in the positive electrode layer means that the solid electrolyte has a T_{I}-type crystal structure, and in a broad sense, it means that the solid electrolyte has a crystal structure that can be recognized as a T_{I}-type crystal structure by those skilled in the art of the solid-state battery. In a narrow sense, the fact that the solid electrolyte has a T_{I}-type structure in the positive electrode layer means that the solid electrolyte shows one or more main peaks corresponding to a Miller index inherent to a so-called T_{I}-Li₃VO₄-type crystal structure at a predetermined incident angle in X-ray diffraction. A compound having a T_{I}-type structure (that is, a solid electrolyte) is described, for example, in the document “J. solid state chem” (A. R. West et. al, J. solid state chem., 4, 20-28 (1972)), and an example thereof includes ICDD Card No. 00-024-0668.

The fact that the solid electrolyte has a T_{II}-type structure in the positive electrode layer means that the solid electrolyte has a T_{II}-type crystal structure, and in a broad sense, it means that the solid electrolyte has a crystal structure that can be recognized as a T_{II}-type crystal structure by those skilled in the art of the solid-state battery. In a narrow sense, the fact that the solid electrolyte has a T_{II}-type structure in the positive electrode layer means that the solid electrolyte shows one or more main peaks corresponding to a Miller index inherent to a so-called T_{II}-Li₃VO₄-type crystal structure at a predetermined incident angle in X-ray diffraction. A compound having a T_{II}-type structure (that is, a solid electrolyte) is described, for example, in the document “J. solid state chem” (A. R. West et. al, J. solid state chem., 4, 20-28 (1972)), and an example thereof includes ICDD Card No. 00-024-0669.

The fact that the solid electrolyte has a γ₀-type structure in the positive electrode layer means that the solid electrolyte has a γ₀-type crystal structure, and in a broad sense, it means that the solid electrolyte has a crystal structure that can be recognized as a γ₀-type crystal structure by those skilled in the art of the solid-state battery. In a narrow sense, the fact that the solid electrolyte has a γ₀-type structure in the positive electrode layer means that the solid electrolyte shows one or more main peaks corresponding to a Miller index inherent to a so-called γ₀-Li₃VO₄-type crystal structure at a predetermined incident angle in X-ray diffraction. A compound having a γ₀-type structure (that is, a solid electrolyte) is described, for example, in the document “J. solid state chem” (A. R. West et. al, J. solid state chem., 4, 20-28 (1972)), and as an example thereof, for example, XRD data (the d-values of the interplanar distance and the Miller indices corresponding thereto) described in the following table is shown.

TABLE 3

| | Li [symbol] CoSiO [symbol] | | |
|---|---|---|---|
| | γ [symbol] , 25° C. | | |
| d(Å) | I | | h k l |
| 5.4 | 60 | | 1 1 0, 0 2 0 |
| 4.08 | 80 | | 1 2 0 |
| 3.92 | 60 | | 1 0 1 |
| 3.69 | 20 | | |
| | | {close oversize brace} | 1 1 1, 0 2 1 |
| 3.67 | 100 | | |
| 3.16 | 20 | | 1 2 1 |
| 3.10 | 60 | | 2 0 0, 1 3 0, 2 1 0 |
| 2.90 | 20 | | 0 3 1 |
| 2.71 | 100 | | 2 2 0 |
| 2.68 | 60 | | 0 4 0 |
| 2.65 | 20 | | |
| | | {close oversize brace} | 1 3 1 |
| 2.64 | 20 | | |
| 2.59 | 20 | | |
| | | {close oversize brace} | 2 1 1 |
| 2.57 | 20 | | |
| 2.51, | 100 | | 0 0 2 |

[symbol]

indicates data missing or illegible when filed

In the positive electrode layer, from the viewpoint of further improving the cycle characteristics, the solid electrolyte preferably has an average chemical composition represented by the chemical formula (1).

(Li_{[3-ax+(5-b)}]Aₓ)BO₄ (1)

When the solid electrolyte has such a chemical composition, the solid electrolyte having the LISICON-type structure is easily obtained, and relatively high ionic conductivity can be obtained.

In the chemical formula (1), A is one or more elements selected from the group consisting of Na (sodium), K (potassium), Mg (magnesium), Ca (calcium), Al (aluminum), Ga (gallium), Zn (zinc), Fe (iron), Cr (chromium), and Co (cobalt).

B is one or more elements selected from the group consisting of Zn (zinc), Al (aluminum), Ga (gallium), Si (silicon), Ge (germanium), Sn (tin), V (vanadium), P (phosphorus), As (arsenic), Ti (titanium), Mo (molybdenum), W (tungsten), Fe (iron), Cr (chromium), and Co (cobalt).

x has a relationship of 0≤x≤1.0 and particularly 0≤x≤0.2.

a is an average valence of A. The average valence of A is, for example, a value represented by (n1×a+n2×b+n3×c)/(n1+n2+n3) when n1 elements X having a valence a+, n2 elements Y having a valence b+, and n3 elements Z having a valence c+ are recognized as A.

b is an average valence of B. The average valence of B is, for example, the same value as the average valence of A described above when n1 elements X having a valence a+, n2 elements Y having a valence b+, and n3 elements Z having a valence c+ are recognized as B.

“3−ax+(5−b)” has a relationship of 3.0≤[3−ax+(5−b)]<4.0, and preferably a relationship of 3.1≤[3−ax+(5−b)]<3.5.

In the chemical formula (1), from the viewpoint of ease availability of the solid electrolyte having the LISICON-type structure, in a preferred embodiment, the following is satisfied.

x is 0.

B is one or more and particularly two elements selected from the group consisting of Si, Ge, V, P, and Ti.

a is an average valence of A, and is the same as the average valence of A in the above chemical formula (1).

b is an average valence of B, and is the same as the average valence of B in the above chemical formula (1).

“3−ax+(5−b)” preferably has a relationship of 3.15≤[3−ax+(5−b)]<3.45, more preferably a relationship of 3.15≤[3−ax+(5−b)]<3.4, and still more preferably a relationship of 3.2≤[3−ax+(5−b)] 3.35.

In the positive electrode layer, from the viewpoint of further improving the cycle characteristics, among the solid electrolytes represented by the above chemical formula (1), the solid electrolyte more preferably has an average chemical composition represented by the chemical formula (2).

(Li_{[3-ax+(5-c)(1-y)}]Aₓ)(B_{y}C_{1-y})O₄ (2)

The solid electrolyte having the LISICON-type structure has the above composition, thereby the cycle characteristics can be further improved. The reason for this is not necessarily clear, but this is considered to be because the side reaction between the positive electrode active material and the solid electrolyte having the LISICON-type structure during charging and discharging can be suppressed by having the composition as described above. As the above side reaction, for example, oxidative decomposition of the LISICON-type solid electrolyte is considered.

In the chemical formula (2), A is one or more elements selected from the group consisting of Na, K, Mg, Ca, Al, Ga, Zn, Fe, Cr, and Co.

B is one or more elements selected from the group consisting of V and P.

C is one or more elements selected from the group consisting of Zn, Al, Ga, Si, Ge, Sn, As, Ti, Mo, W, Fe, Cr, and Co.

x has a relationship of 0≤x≤1.0 and particularly 0≤x≤0.2.

y has a relationship of 0.5<y<1.0, preferably a relationship of 0.55≤y≤0.95, and more preferably a relationship of 0.65≤y≤0.85.

a is an average valence of A, and is the same as the average valence of A in the chemical formula (1).

c is an average valence of B, and is the same as the average valence of B in the chemical formula (1).

“3−ax+(5−c)(1−y)” has a relationship of 3.0≤[3−ax+(5−c)(1−y)] 4.0, and preferably a relationship of 3.1≤[3−ax+(5−c)(1−y)]<3.5.

In the chemical formula (2), from the viewpoint of the balance between further improvement in cycle characteristics and further improvement in ease availability of the solid electrolyte having the LISICON-type structure, in a preferred embodiment, the following is satisfied.

x is 0.

y has a relationship of 0.65≤y≤0.85 and preferably a relationship of 0.7≤y≤0.8.

B is one or more elements selected from the group consisting of V and P.

C is one or more and particularly two elements selected from the group consisting of Si, Ge, and Ti.

a is an average valence of A, and is the same as the average valence of A in the chemical formula (1).

c is an average valence of B, and is the same as the average valence of B in the chemical formula (1).

“3−ax+(5−c)(1−y)” preferably has a relationship of 3.15≤[3−ax+(5−c)(1−y)]≤3.45, more preferably a relationship of 3.15≤[3−ax+(5−c)(1−y)]<3.4, and still more preferably a relationship of 3.2≤[3−ax+(5−c)(1−y)] 3.35.

The average chemical composition of the solid electrolyte in the positive electrode layer means an average value of the chemical composition of the solid electrolyte in a thickness direction of the solid electrolyte. The average chemical composition of the solid electrolyte can be analyzed and measured by breaking the solid-state battery and performing composition analysis by EDX using SEM-EDX (energy dispersive X-ray spectroscopy) in a field of view which fits the whole thickness direction of the positive electrode layer.

In the positive electrode layer, the average chemical composition of the positive electrode active material and the average chemical composition of the solid electrolyte described later can be automatically distinguished and measured according to their compositions in the composition analysis described above.

The chemical composition and the crystal structure of the solid electrolyte in the positive electrode layer may be usually changed by element diffusion during sintering in the manufacturing process of the solid-state battery. The solid electrolyte of the positive electrode layer preferably has the average chemical composition and the crystal structure described above in the solid-state battery after being sintered together with a negative electrode layer and the solid electrolyte layer.

The volume ratio of the solid electrolyte in the positive electrode layer is not particularly limited, and is preferably 10% to 80%, more preferably 20% to 60%, and still more preferably 40% to 60% from the viewpoint of the balance between further improvement in cycle characteristics and high energy density of the solid-state battery.

The volume ratio of the solid electrolyte in the positive electrode layer can be measured by the same method as that for the volume ratio of the positive electrode active material.

The positive electrode layer may further include, for example, a sintering additive, a conductive additive, or the like in addition to the positive electrode active material and the solid electrolyte.

The positive electrode layer includes a sintering additive, thereby the positive electrode layer can be densified during sintering at a lower temperature, and element diffusion at the interface between the positive electrode active material and the solid electrolyte can be suppressed. As the sintering additive, a sintering additive known in the field of the solid-state battery can be used. From the viewpoint of further improving the cycle characteristics, the inventors have conducted studies, and as a result, they have found that the composition of the sintering additive preferably includes at least Li, B, and O, and the molar ratio of Li to B (Li/B) is preferably 2.0 or more. These sintering additives have low melting properties, and the negative electrode layer can be densified at a lower temperature by progressing liquid phase sintering. In addition, it was found that the sintering additive had the above composition, thereby the side reaction between the sintering additive and the LISICON-type solid electrolyte used in the present invention could be further suppressed during co-sintering. Examples of the sintering additive satisfying these conditions include Li₄B₂O₅, Li_{2.4}Al_{0.2}BO₃, and Li₃BO₃. Among those, Li_{2.4}A1_{0.2}BO₃ having a particularly high ionic conductivity is particularly preferably used.

The volume ratio of the sintering additive in the positive electrode layer is not particularly limited, and is preferably 0.1% to 10%, and more preferably 3% to 7% from the viewpoint of the balance between further improvement in cycle characteristics and high energy density of the solid-state battery.

The volume ratio of the sintering additive in the positive electrode layer can be measured by the same method as that for the volume ratio of the positive electrode active material.

As the conductive additive in the positive electrode layer, the conductive additive known in the field of the solid-state battery can be used. From the viewpoint of further improving the cycle characteristics, examples of the conductive additive preferably used include a metal material such as Ag, Au, Pd, Pt, Cu, or Sn; and a carbon material such as a carbon nanotube such as acetylene black, Ketjenblack, Super P (registered trademark), or VGCF (registered trademark). Since the positive electrode active material used in the present invention has electron conductivity, the conductive additive may not be used.

In the positive electrode layer, the porosity is not particularly limited, and is preferably 20% or less, more preferably 15% or less, and still more preferably 10% or less from the viewpoint of further improving the cycle characteristics.

As the porosity of the positive electrode layer, a value measured from a SEM image after FIB sectional processing using A image-kun is used.

The positive electrode layer is a layer that can be referred to as a “positive electrode active material layer”. The positive electrode layer may have a so-called positive electrode current collector or positive electrode current collecting layer.

(Negative Electrode Layer)

In the present invention, the negative electrode layer is not particularly limited. For example, the negative electrode layer includes a negative electrode active material. The negative electrode layer may have a form of a sintered body including negative electrode active material particles.

The negative electrode active material is not particularly limited, and a negative electrode active material known in the art of the solid-state battery can be used. Examples of the negative electrode active material include a graphite-lithium compound, a lithium metal, lithium alloy particles, a phosphate compound having a NASICON-type structure, a Li-containing oxide having a spinel-type structure, and an oxide having a β_{II}-Li₃VO₄-type structure or a γ_{II}Li₃VO₄⁻type structure. As the negative electrode active material, a lithium metal and a Li-containing oxide having a β11-Li₃VO₄-type structure or a y_{II}-Li₃VO₄-type structure are preferably used.

The fact that the oxide has a β_{II}-Li₃VO₄-type structure in the negative electrode layer means that the oxide (particularly, particles thereof) has a β_{II}⁻Li₃VO₄⁻type crystal structure, and in a broad sense, it means that the oxide has a crystal structure that can be recognized as a β_{II}-Li₃VO₄-type crystal structure by those skilled in the art of the solid-state battery. In a narrow sense, the fact that the oxide has a β_{II}-Li₃VO₄-type structure in the negative electrode layer means that the oxide (particularly, particles thereof) shows one or more main peaks corresponding to a Miller index unique to a so-called β_{II}-Li₃VO₄-type crystal structure at a predetermined incident angle in X-ray diffraction. Examples of the Li-containing oxide having a β_{II}-Li₃VO₄-type structure preferably used include Li₃VO₄.

The fact that the oxide has a γ_{II}-Li₃VO₄-type structure in the negative electrode layer means that the oxide (particularly, particles thereof) has a γ_{II}-Li₃VO₄-type crystal structure, and in a broad sense, it means that the oxide has a crystal structure that can be recognized as a γ_{II}-Li₃VO₄-type crystal structure by those skilled in the art of the solid-state battery. In a narrow sense, the fact that the oxide has a γ_{II}-Li₃VO₄-type structure in the negative electrode layer means that the oxide (particularly, particles thereof) shows one or more main peaks corresponding to a Miller index inherent to a so-called γ_{II}-Li₃VO₄-type crystal structure at a predetermined incident angle (x axis) in X-ray diffraction. Examples of the Li-containing oxide having a γ_{II}-Li₃VO₄-type structure preferably used include Li_{3.2}V_{0.8}Si_{0.2}O₄.

The fact that the oxide has a γ_{II}-Li₃VO₄-type structure in the negative electrode layer means that the oxide has a γ_{II}-Li₃VO₄-type crystal structure, and in a broad sense, it means that the oxide has a crystal structure that can be recognized as a γ_{II}-Li₃VO₄-type crystal structure by those skilled in the art of the solid-state battery. In a narrow sense, the fact that the oxide has a γ_{II}Li₃VO₄-type structure in the negative electrode layer means that the oxide shows one or more main peaks corresponding to a Miller index unique to a so-called γ_{II}-Li₃VO₄-type crystal structure at a predetermined incident angle in X-ray diffraction.

Examples of the Li-containing oxide having a LISICON-type structure preferably used include Li₃₊ₓ(V)₁₋ₓ(Si, Ge)ₓO₄ (0<x<1). Specific examples of the Li-containing oxide having such a LISICON-type structure include Li_{3.1}V_{0.9}Si_{0.1}O₄, Li_{3.2}V_{0.8}Si_{0.2}O₄, Li_{3.3}V_{0.7}Si_{0.3}O₄, and Li_{3.3}V_{0.7}Ge_{0.3}O₄.

The chemical composition of the negative electrode active material may be an average chemical composition. The average chemical composition of the negative electrode active material means an average value of the chemical composition of the negative electrode active material in a thickness direction of the negative electrode layer. The average chemical composition of the negative electrode active material can be analyzed and measured by breaking the solid-state battery and performing composition analysis by EDX using SEM-EDX (energy dispersive X-ray spectroscopy) in a field of view which fits the whole thickness direction of the negative electrode layer.

The chemical composition and the crystal structure of the negative electrode active material in the negative electrode layer may be usually changed by element diffusion during sintering in a manufacturing process of the solid-state battery. The negative electrode active material preferably has the average chemical composition and the crystal structure described above in the solid-state battery after being sintered together with the positive electrode layer and the solid electrolyte layer.

The volume ratio of the negative electrode active material in the negative electrode layer is not particularly limited, and is preferably 50% or more (particularly, 50% to 99%), more preferably 70% to 95%, and still more preferably 80% to 90% from the viewpoint of the balance between further improvement in cycle characteristics and high energy density of the solid-state battery.

The negative electrode layer may further include, for example, the sintering additive, the conductive additive, or the like in addition to the negative electrode active material.

As the sintering additive in the negative electrode layer, the same compound as the sintering additive in the positive electrode layer can be used.

As the conductive additive in the negative electrode layer, the same compound as the conductive additive in the positive electrode layer can be used.

In the negative electrode layer, the porosity is not particularly limited, and is preferably 20% or less, more preferably 15% or less, and still more preferably 10% or less from the viewpoint of further improving the cycle characteristics.

As the porosity of the negative electrode layer, a value measured by the same method as that for the porosity of the positive electrode layer is used.

The negative electrode layer is a layer that can be referred to as a “negative electrode active material layer”. The negative electrode layer may have a so-called negative electrode current collector or negative electrode current collecting layer.

(Solid Electrolyte Layer)

In the present invention, from the viewpoint of further improving the cycle characteristics, the solid electrolyte layer preferably includes, as the solid electrolyte, an oxide having a garnet-type structure or an oxide having a LISICON-type structure (particularly, an oxide having a garnet-type structure). Such a solid electrolyte is used, thereby the reactivity between the positive electrode active material and the solid electrolyte used in the positive electrode layer in the present invention can be further reduced. The solid electrolyte layer preferably has a form of the sintered body including the solid electrolyte.

The fact that the oxide has a garnet-type structure in the solid electrolyte layer means that the oxide has a garnet-type crystal structure, and in a broad sense, it means that the solid electrolyte has a crystal structure that can be recognized as a garnet-type crystal structure by those skilled in the art of the solid-state battery. In a narrow sense, the fact that the oxide has a garnet-type structure in the solid electrolyte layer means that the oxide shows one or more main peaks corresponding to a Miller index unique to a so-called garnet-type crystal structure at a predetermined incident angle in X-ray diffraction.

The oxide having a garnet-type structure in the solid electrolyte layer preferably has an average chemical composition represented by chemical formula (3).)

(LI_{[7-ax-(b-4)y}]Aₓ)La₃Zr_{2-y}B_{y}O₁₂ (3)

The solid electrolyte layer includes the solid electrolyte having the average chemical composition as described above, thereby the conductivity of the garnet-type solid electrolyte increases while suppressing the side reaction during sintering with the positive electrode active material, therefore a high rate of the battery can be achieved.

In the chemical formula (3), A is one or more elements selected from the group consisting of Ga, Al, Mg, Zn, and Sc.

B is one or more elements selected from the group consisting of Nb, Ta, W, Te, Mo, and Bi.

x has a relationship of 0≤x≤0.5.

y has a relationship of 0≤y≤2.0.

a is an average valence of A, and is the same as the average valence of A in the chemical formula (1).

b is an average valence of B, and is the same as the average valence of B in the chemical formula (1).

In the chemical formula (3), from the viewpoint of the balance between further improvement in cycle characteristics and further improvement in higher rate of the battery, in a preferred embodiment, the following is satisfied.

A is one or more elements selected from the group consisting of Ga, Al, and Mg.

B is one or more elements selected from the group consisting of Nb, Ta, Mo, W, and Bi.

x has a relationship of 0≤x≤0.3.

y has a relationship of 0≤y≤1.0.

a is an average valence of A, and is preferably 2.5 to 3.0, and more preferably 2.8 to 3.0.

b is an average valence of B, and is preferably 5.0 to 7.0, and more preferably 5.0 to 6.1.

The LISICON-type structure of the oxide in the solid electrolyte layer includes a β_{II}-type structure, a β_{II}′-type structure, a T_{I}-type structure, a T_{II}-type structure, a γ_{II}-type structure, and a γ₀-type structure. That is, the solid electrolyte layer may include one or more oxides (that is, solid electrolytes) having a β_{II}-type structure, a β_{II}-type structure, a T_{I}-type structure, a T_{II}-type structure, a γ_{II}-type structure, a γ₀-type structure, or a composite structure thereof.

The β_{II}-type structure, the β_{II}′-type structure, the T_{I}-type structure, the T_{II}-type structure, the γ_{II}-type structure, and the γ₀-type structure as the LISICON-type structures for the oxide that can be included in the solid electrolyte layer are the same as the β_{II}-type structure, the β_{II}′-type structure, the T_{I}-type structure, the T_{II}-type structure, the γ_{II}-type structure, and the γ₀-type structure for the solid electrolyte having the LISICON type structure included in the positive electrode layer, respectively.

Examples of the oxide having the LISICON-type structure that can be included in the solid electrolyte layer include the same compound as the solid electrolyte having the LISICON-type structure included in the positive electrode layer, for example, a solid electrolyte having an average chemical composition represented by the chemical formula (1) (particularly, the chemical formula (2)). The solid electrolyte layer includes the solid electrolyte having the average chemical composition as described above, thereby relatively high ionic conductivity can be obtained while achieving improvement in cycle characteristics.

The chemical composition and the crystal structure of the solid electrolyte in the solid electrolyte layer may be usually changed by element diffusion during sintering in a manufacturing process of the solid-state battery. The solid electrolyte of the solid electrolyte layer preferably has the average chemical composition and the crystal structure described above in the solid-state battery after being sintered together with the negative electrode layer and the positive electrolyte layer.

The volume ratio of the solid electrolyte in the solid electrolyte layer is not particularly limited, and is preferably 50% or more (particularly, 50% to 100%), more preferably 80% to 100%, and still more preferably 90% to 100% from the viewpoint of further improving the cycle characteristics.

The solid electrolyte layer may further include, for example, the sintering additive or the like in addition to the solid electrolyte.

As the sintering additive in the solid electrolyte layer, the same compound as the sintering additive in the positive electrode layer can be used.

In the solid electrolyte layer, the porosity is not particularly limited, and is preferably 15% or less, more preferably 10% or less, and still more preferably 5% or less from the viewpoint of further improving the cycle characteristics.

As the porosity of the solid electrolyte, a value measured by the same method as that for the porosity of the positive electrode layer is used.

[Method for Manufacturing Solid-State Battery]

The solid-state battery can be manufactured, for example, by a so-called green sheet method or a printing method.

The green sheet method will be described.

First, a solvent, a resin, and the like are appropriately mixed with the positive electrode active material and the solid electrolyte to prepare a paste. The paste is applied onto a sheet and dried to form a first green sheet for constituting the positive electrode layer. The first green sheet may include the conductive additive and/or the sintering additive.

A solvent, a resin, and the like are appropriately mixed with the negative electrode active material to prepare a paste. The paste is applied onto a sheet and dried to form a second green sheet for constituting the negative electrode layer. The second green sheet may include the solid electrolyte, the conductive additive and/or the sintering additive.

A solvent, a resin, and the like are appropriately mixed with the solid electrolyte to prepare a paste. The paste is applied onto a sheet and dried to produce a third green sheet for constituting the solid electrolyte layer.

Next, the first to third green sheets are appropriately laminated to produce a laminate. The produced laminate may be pressed. Examples of the preferable pressing method include an isostatic pressing method.

Thereafter, the laminate is sintered at, for example, 600 to 800° C. to be able to obtain a solid-state battery.

A printing method will be described.

The printing method is the same as the green sheet method except for the following matters.

An ink of each layer having the same composition as the composition of the paste of each layer for obtaining the green sheet is prepared except that the blending amount of the solvent and the resin is set to the blending amount suitable for use as an ink.

The ink of each layer is used for printing and laminating to produce a laminate.

Hereinafter, the present invention will be described in more detail based on specific Examples, but the present invention is not limited to the following Examples at all, and can be appropriately changed and implemented within a range not to change the gist thereof.

### EXAMPLES

### Examples 1 to 28 and Comparative Examples 1 to 11

(1) Manufacture of solid-state battery

The solid-state batteries of each of Examples and Comparative Examples were manufactured as follows.

First, the solid electrolyte powder, the positive electrode active material powder, and the sintering additive powder manufactured in each of (3) to (5) described later were weighed so as to be a volume ratio of 45:50:5, respectively, and kneaded with an alcohol and a binder to prepare a positive electrode layer paste.

Next, the prepared positive electrode layer paste was applied onto the solid electrolyte substrate manufactured in (2) described later, and sufficiently dried. This was heated at 400° C. to remove the binder and then heat-treated at 750° C. for 1 hour to bake the positive electrode layer on the solid electrolyte substrate.

Au was sputtered as a current collector on the surface of the positive electrode layer on the side opposite to the solid electrolyte substrate.

Thereafter, metal Li as a counter electrode and a reference electrode was attached to a surface of the solid electrolyte substrate on the side opposite to the positive electrode layer, and the solid electrolyte substrate was sealed with a 2032 type coin cell to obtain a solid-state battery.

In the solid-state batteries of Examples 1 to 28 and Comparative Examples 1 to 7 manufactured by the method as described above, it was confirmed that the porosity in the positive electrode layer was 10% or less for all samples, from a SEM image after FIB sectional processing. Note that, in Comparative Examples 5 to 8, the side reaction occurred at the interface between the electrode and the electrolyte during co-sintering, thereby densification in the positive electrode layer did not progress. The average volume ratios of the positive electrode active material and the solid electrolyte in the positive electrode layer were 45 to 50 volume % and 40 to 45 volume %, respectively in all Examples and Comparative Examples.

The solid-state batteries of Examples 1 to 11 have a positive electrode layer in which the positive electrode active material is LiCoO₂ having the layered rock salt-type structure, the solid electrolyte is Li_{3.2}V_{0.8}Si_{0.2}O₄ having a LISICON-type structure, and LiCoO₂ as the positive electrode active material has a particle size of 4 μm or less.

The solid-state batteries of Comparative Examples 1 to 3 are the same as the solid-state battery of Example 1 except that they have the positive electrode layer in which the particle size of the positive electrode active material is larger than 4 μm.

The solid-state batteries of Comparative Examples 4 and 5 are the same as the solid-state battery of Example 1 except that the solid electrolyte in the positive electrode layer is perovskite-type La_{0.56}Li_{0.3}TiO₃, and the positive electrode active material has a predetermined average particle size.

The solid-state batteries of Comparative Examples 6 and 7 are the same as the solid-state battery of Example 1 except that the solid electrolyte in the positive electrode layer is Li₂CO₃—Li₃BO₃-based Li_{2.2}C_{0.8}B_{0.2}O₃, and the positive electrode active material has a predetermined average particle size.

The solid-state batteries of Comparative Examples 8 and 9 are the same as the solid-state battery of Example 1 except that the positive electrode active material in the positive electrode layer is olivine-type LiFePO₄, and the positive electrode active material has a predetermined average particle size.

The solid-state batteries of Comparative Examples 10 and 11 are the same as the solid-state battery of Example 1 except that the positive electrode active material in the positive electrode layer is NASICON-type Li₃V₂(PO₄)₃, and the positive electrode active material has a predetermined average particle size.

The solid-state batteries of Examples 12 to 20 are the same as the solid-state battery of Example 1 except that the composition of the solid electrolyte having the LISICON-type structure in the positive electrode layer is changed to a predetermined composition and the positive electrode active material has a predetermined average particle size.

The solid-state batteries of Examples 21 to 28 are the same as the solid-state battery of Example 1 except that the composition of the positive electrode active material having the layered rock salt-type structure in the positive electrode layer is changed to a predetermined composition and the positive electrode active material has a predetermined average particle size.

(2) Manufacture of Garnet-Type Solid Electrolyte Substrate

The solid electrolyte substrates of all Examples and Comparative Examples were manufactured as follows.

As a raw material, lithium hydroxide monohydrate LiOH.H₂O, lanthanum hydroxide La(OH)₃, zirconium oxide ZrO₂, and tantalum oxide Ta₂O₅ were used.

Each of starting materials was weighed so as to have a chemical composition of Li_{6.6}La₃Zr_{1.6}Ta_{0.4}O₁₂, water was added thereto, the resulting mixture was sealed in a polypot made of polyethylene, and the pot was rotated at 150 rpm for 16 hours on a pot rack to mix the raw materials. In addition, lithium hydroxide monohydrate LiOHH₂O as a Li source was charged in an excess of 3 weight % with respect to the target composition in consideration of Li deficiency during sintering.

The obtained slurry was evaporated and dried, and then calcined in O₂ at 900° C. for 5 hours to obtain a target phase.

A mixed solvent of toluene and acetone was added to the obtained calcined powder, and the calcined powder was pulverized for 12 hours with a planetary ball mill.

The obtained solid electrolyte powder, a butyral resin, and an alcohol were well mixed at a weight ratio of 200:15:140, and then the alcohol was removed on a hot plate at 80° C. to obtain a powder coated with the butyral resin serving as a binder.

Then, the coated powder was pressed at 90 MPa using a tablet forming machine to mold into a tablet shape.

The tablet was sufficiently covered with a mother powder, and subjected to a degreasing treatment at a temperature of 500° C. under an oxygen atmosphere to remove the butyral resin, and then sintered at about 1200° C. for 3 hours under an oxygen atmosphere, and the temperature was lowered to room temperature to obtain a sintered body of the solid electrolyte.

The surface of the obtained sintered body was polished to obtain a garnet-type solid electrolyte substrate.

(3) Manufacture of Solid Electrolyte Powder Used in Positive Electrode Layer

The LISICON-type solid electrolytes of Comparative Examples 1 to 3 and 8 to 11 and Examples 1 to 28 were manufactured as follows.

As a raw material, lithium hydroxide monohydrate LiOHH₂O, vanadium pentoxide V₂O₅, silicon oxide SiO₂, titanium oxide TiO₂, germanium oxide GeO₂, and phosphorus oxide P₂O₅ were used. Each of starting materials was appropriately weighed so that the solid electrolyte had a predetermined chemical composition, water was added thereto, the resulting mixture was sealed in a polypot made of polyethylene, and the polypot was rotated at 150 rpm for 16 hours on a pot rack to mix the raw materials.

The obtained slurry was evaporated and dried, and then calcined in air at 800° C. for 5 hours.

An alcohol was added to the obtained calcined powder, and the resulting mixture was sealed again in a 100 ml polypot made of polyethylene, and the polypot was rotated at 150 rpm for 16 hours on a pot rack to pulverize the calcined powder.

The pulverized powder was sintered again at 900° C. for 5 hours.

Thereafter, a mixed solvent of toluene and acetone was added to the obtained sintered powder, and the sintered powder was pulverized for 12 hours with a planetary ball mill and dried to obtain a solid electrolyte powder.

The perovskite-type solid electrolytes used in the positive electrode layers of Comparative Examples 4 and 5 were manufactured as follows.

As a raw material, lithium hydroxide monohydrate LiOH.H₂O, lanthanum hydroxide La(OH)₃, and titanium oxide TiO₂ were used.

Each of starting materials was appropriately weighed so that the solid electrolyte had a predetermined chemical composition, water was added thereto, the resulting mixture was sealed in a polypot made of polyethylene, and the polypot was rotated at 150 rpm for 16 hours on a pot rack to mix the raw materials. In addition, lithium hydroxide monohydrate LiOHH₂O as a Li source was charged in an excess of 3 weight % with respect to the target composition in consideration of Li deficiency during sintering.

The obtained slurry was evaporated and dried, and then calcined in O₂ at 1000° C. for 5 hours to obtain a target phase.

A mixed solvent of toluene and acetone was added to the obtained sintered powder, and the sintered powder was pulverized for 12 hours with a planetary ball mill and dried to obtain a solid electrolyte powder.

The Li₂CO₃—Li₃BO₃-based solid electrolytes used in the positive electrode layers of Comparative Examples 6 and 7 were manufactured as follows.

Lithium hydroxide monohydrate LiOHH₂O, lithium carbonate Li₂CO₃, and boron oxide B₂O₃ were used. Each of starting materials was appropriately weighed so that the solid electrolyte had a predetermined chemical composition, well mixed in a mortar, and then calcined at 650° C. for 5 hours.

A mixed solvent of toluene and acetone was added to the obtained sintered powder, and the sintered powder was pulverized for 12 hours with a planetary ball mill and dried to obtain a solid electrolyte powder.

(4) Manufacture of Positive Electrode Active Material Powder Used in Positive Electrode Layer

The positive electrode active materials used in the positive electrode layers shown in Comparative Examples 1 to 3 and Examples 5 to 20 and 26 to 28 were produced by a solid phase reaction method. Lithium carbonate Li₂CO₃, nickel oxide NiO, manganese oxide MnO₂, cobalt oxide Co₃O₄, aluminum oxide Al₂O₃, and magnesium oxide MgO were used. Each of starting materials was weighed so as to have a predetermined chemical composition, well mixed in a mortar, and then calcined at 700° C. to 900° C. for 5 to 20 hours. LiCoO₂ particles having different particle sizes were obtained by appropriately changing the particle size of Co₃O₄ as a raw material and the calcination time. Co₃O₄ which is used as a raw material and has a particle size of 0.3 μm to 9.0 μm was appropriately used.

The positive electrode active material used in the positive electrode layer in Examples 1 to 4 was produced by a liquid phase method. Lithium acetate CH₃COOLi and cobalt acetate tetrahydrate Co(C₂H₃O₂)₂.4H₂O were weighed so as to have a predetermined chemical composition and dissolved in water, and then citric acid was added thereto as a complex-forming material. Thereafter, the mixture was heated in an oil bath at 60° C., and the obtained gel was calcined at 500° C. for 2 hours. Thereafter, the resultant was calcined at 700° C. to 800° C. for 1 to 5 hours to obtain LiCoO₂ particles having different particle sizes.

The positive electrode active materials used in the positive electrode layers shown in Examples 21 to 25 were produced by a solid phase reaction method. Lithium hydroxide LiOH, nickel hydroxide Ni(OH)₂, manganese oxide Mn₂O₃, and cobalt nitrate hexahydrate Co(NO)₃.6H₂O were used. Each of starting materials was weighed so as to have a predetermined chemical composition, well mixed in a mortar, and then calcined at 800° C. to 900° C. for 5 to 20 hours. After the calcination, aggregates were crushed using a ball mill.

The predetermined particle size of the positive electrode active material in the positive electrode layer was controlled by adjusting the particle size of the positive electrode active material powder.

(5) Manufacture of Sintering Additive Powder Used in Positive Electrode Layer

The sintering additives of Comparative Example 1 to 11 and Example 1 to 28 were manufactured as follows.

Lithium hydroxide monohydrate LiOH.H₂O, boron oxide B₂O₃, and aluminum oxide Al₂O₃ were used. Each of starting materials was appropriately weighed so that the chemical composition of the sintering additive was Li₂.4Al_{0.2}BO₃, well mixed in a mortar, and then calcined at 650° C. for 5 hours.

Thereafter, the calcined powder was pulverized and mixed again well in a mortar, and then sintered at 680° C. for 40 hours.

A mixed solvent of toluene and acetone was added to the obtained sintered powder, and the sintered powder was pulverized for 6 hours with a planetary ball mill and dried to obtain a sintering additive powder.

[Evaluation of Solid-State Battery]

The solid-state batteries of Comparative Example 1 to 11 and Examples 1 to 28 were evaluated as follows.

By the constant current charge/discharge test, the electrical quantity was measured in a potential range of 3.0 V to 4.2 V (vs. Li/Li+) at a current density equivalent to 0.05 C at 25° C.

The initial discharge capacitance was calculated by dividing the initial electrical quantity obtained from the constant current charge/discharge test by the weight of the positive electrode active material. The capacitance maintenance ratio R after 10 cycles was calculated by dividing the discharge capacitance at the 10th cycle by the initial discharge capacitance.

⊙⊙; 99%≤R≤100% (best);

⊙; 97%≤R<99% (excellent);

◯; 90%≤R<97% (good);

Δ; 75%≤R<90% (acceptable)(no problem in practical use); and

X; R<75% (not acceptable)(problem in practical use).

TABLE 4

| | Positive electrode layer | | | | Capacitance |
|---|---|---|---|---|---|
| | | | Average particle | Initial | maintenance |
| | | | size of positive | discharge | ratio after |
| | Positive electrode active | | electrode active | capacitance | 10 cycles |
| | material | Solid electrolyte | material (μm) | (mAh/g) | (%) |
| Example 1 | LiCoO₂ (Layered rock salt-type) | Li_{3.2}V_{0.8}Si_{0.2}O₄ (LISICON-type (γ_{II}-Li₃VO₄-type)) | 0.063 | 120 | 95.5% ◯ |
| Example 2 | LiCoO₂ (Layered rock salt-type) | Li_{3.2}V_{0.8}Si_{0.2}O₄ (LISICON-type (γ_{II}-Li₃VO₄-type)) | 0.082 | 122 | 97.1% ⊙ |
| Example 3 | LiCoO₂ (Layered rock salt-type) | Li_{3.2}V_{0.8}Si_{0.2}O₄ (LISICON-type (γ_{II}-Li₃VO₄-type)) | 0.15 | 128 | 99.9% ⊙⊙ |
| Example 4 | LiCoO₂ (Layered rock salt-type) | Li_{3.2}V_{0.8}Si_{0.2}O₄ (LISICON-type (γ_{II}-Li₃VO₄-type)) | 0.22 | 134 | 99.0% ⊙⊙ |
| Example 5 | LiCoO₂ (Layered rock salt-type) | Li_{3.2}V_{0.8}Si_{0.2}O₄ (LISICON-type (γ_{II}-Li₃VO₄-type)) | 0.48 | 134 | 99.6% ⊙⊙ |
| Example 6 | LiCoO₂ (Layered rock salt-type) | Li_{3.2}V_{0.8}Si_{0.2}O₄ (LISICON-type (γ_{II}-Li₃VO₄-type)) | 0.60 | 132 | 98.2% ⊙ |
| Example 7 | LiCoO₂ (Layered rock salt-type) | Li_{3.2}V_{0.8}Si_{0.2}O₄ (LISICON-type (γ_{II}-Li₃VO₄-type)) | 0.80 | 128 | 98.6% ⊙ |
| Example 8 | LiCoO₂ (Layered rock salt-type) | Li_{3.2}V_{0.8}Si_{0.2}O₄ (LISICON-type (γ_{II}-Li₃VO₄-type)) | 1.2 | 134 | 96.0% ◯ |
| Example 9 | LiCoO₂ (Layered rock salt-type) | Li_{3.2}V_{0.8}Si_{0.2}O₄ (LISICON-type (γ_{II}-Li₃VO₄-type)) | 2.3 | 123 | 94.5% ◯ |
| Example 10 | LiCoO₂ (Layered rock salt-type) | Li_{3.2}V_{0.8}Si_{0.2}O₄ (LISICON-type (γ_{II}-Li₃VO₄-type)) | 2.9 | 119 | 86.9% Δ |
| Example 11 | LiCoO₂ (Layered rock salt-type) | Li_{3.2}V_{0.8}Si_{0.2}O₄ (LISICON-type (γ_{II}-Li₃VO₄-type)) | 3.2 | 130 | 89.0% Δ |
| Comparative | LiCoO₂ (Layered rock salt-type) | Li_{3.2}V_{0.8}Si_{0.2}O₄ (LISICON-type (γ_{II}-Li₃VO₄-type)) | 4.1 | 118 | 73.8% X |
| Example 1 | | | | | |
| Comparative | LiCoO₂ (Layered rock salt-type) | Li_{3.2}V_{0.8}Si_{0.2}O₄ (LISICON-type (γ_{II}-Li₃VO₄-type)) | 6.4 | 116 | 52.0% X |
| Example 2 | | | | | |
| Comparative | LiCoO₂ (Layered rock salt-type) | Li_{3.2}V_{0.8}Si_{0.2}O₄ (LISICON-type (γ_{II}-Li₃VO₄-type)) | 9.1 | 95 | 22.0% X |
| Example 3 | | | | | |

### Examples 1 to 11 and Comparative Examples 1 to 3

In the solid-state battery using LiCoO₂ having the layered rock salt-type structure as the positive electrode active material in the positive electrode layer and Li_{3.2}V_{0.8}Si_{0.2}O₄ having the LISICON-type structure as the solid electrolyte, the initial discharge capacitance and the capacitance maintenance ratio after 10 cycles when the particle size of the positive electrode active material was changed are shown in Table 4.

FIGS. 1 to 3 show charge/discharge curves of the solid-state batteries of Example 4, Example 11, and Comparative Example 2 during 10 cycles, respectively.

From Table 4, it is found that the change in the particle size of the positive electrode active material in the positive electrode layer causes the cycle characteristics to greatly change. It was found that, in the solid-state batteries of Comparative Examples 1 to 3 manufactured using the positive electrode active material having a particle size of 4 μm or more, the capacitance maintenance ratio after 10 cycles was as remarkably low as less than 75%. In particular, in Comparative Example 2, also from the charge/discharge curve of FIG. 3, it can be seen that the discharge capacitance dramatically decreases every cycle. In Comparative Example 2, after charging and discharging, peeling was observed at the interface between the positive electrode active material and the solid electrolyte, which was not observed before charging and discharging. It is considered that when peeling occurs at the interface between the positive electrode active material and the solid electrolyte, Li ions cannot be exchanged at the interface between the positive electrode active material and the solid electrolyte, and therefore the discharge capacitance is dramatically reduced. It is considered that peeling progresses at the interface between the positive electrode active material and the solid electrolyte caused by charging and discharging, thereby the cycle deterioration dramatically progresses.

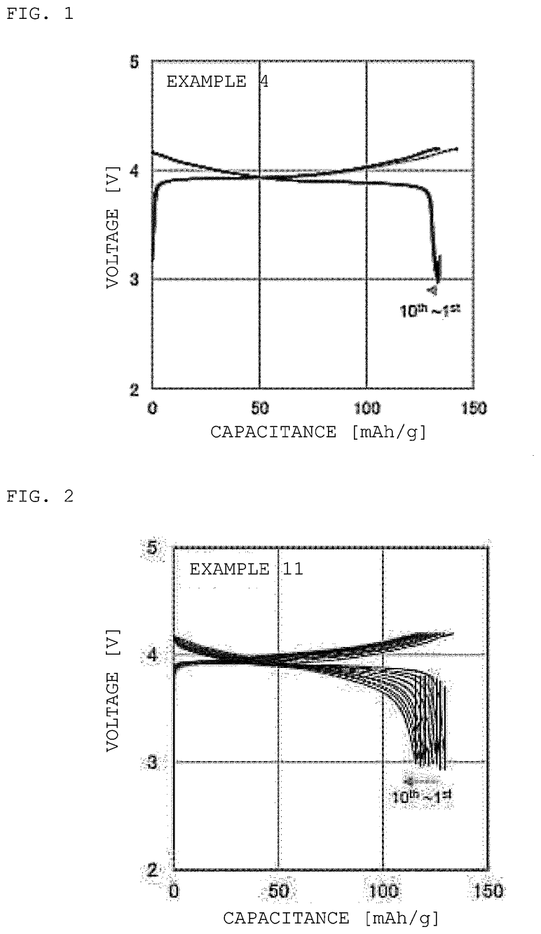

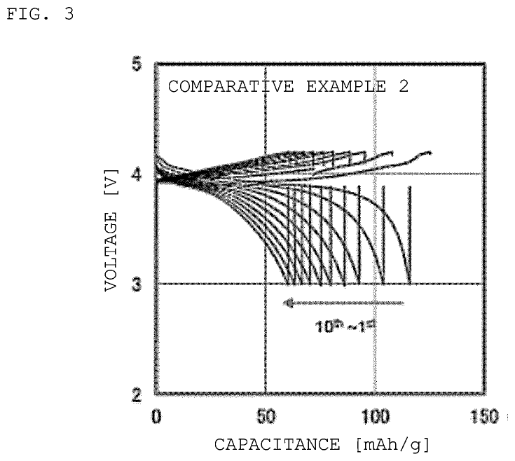

As shown in Examples 1 to 11, it is found that when the particle size of the positive electrode active material is 4 μm or less, the capacitance maintenance ratio is 75% or more, preferably 90% or more, more preferably 97% or more, and still more preferably 99% or more, and the cycle characteristics are remarkably improved, which is therefore preferable. From the charge/discharge curve of Example 11 in FIG. 2, it can be seen that although the discharge capacitance decreases every cycle, cycle deterioration is suppressed as compared with Comparative Example 2 (FIG. 3). When the particle size of the positive electrode active material was 4 μm or less and more than 2.5 μm as shown in Examples 10 to 11, it was confirmed by the charge/discharge test that although peeling was not observed at the interface between the positive electrode active material and the solid electrolyte, cracking was generated in the positive electrode active material and the solid electrolyte. It is considered that the number of Li that can be charged and discharged decreases due to generation of cracking in the positive electrode active material, and the positive electrode active material to which Li ions are not supplied is generated due to generation of cracking in the solid electrolyte, thereby the utilization factor of the active material decreases. It is considered that since peeling does not significantly progress at the interface between the positive electrode active material and the solid electrolyte, dramatic cycle deterioration does not progress, but cracking gradually progress in the positive electrode active material and the solid electrolyte, leading to cycle deterioration.

As shown in Example 1 to 9, it was found that when the particle size of the positive electrode active material was 2.5 μm or less (particularly, 0.04 μm to 2.5 μm), the cycle characteristics were 90% or more, which was therefore preferable.

As shown in Examples 2 to 7, it was found that when the particle size of the positive electrode active material was 0.07 μm to 1.0 μm, the cycle characteristics were 97% or more, which was therefore more preferable.

As shown in Examples 3 to 5, it was found that when the particle size of the positive electrode active material was 0.1 μm to 0.5 μm, the cycle characteristics were 99% or more, which was therefore further preferable. Also from the charge/discharge curve (FIG. 1) of Example 4, it can be seen that there is almost no change in the discharge capacitance and the shape of the charge/discharge curve when the cycles are repeated after the first time. When the particle size of the positive electrode active material was within the above range, peeling between the positive electrode active material particles and the solid electrolyte, and cracking in the positive electrode active material and the solid electrolyte could not be confirmed after the cycle test. This is considered to be a factor exhibiting very high cyclability.

As shown in Examples 1 to 2, it was confirmed that when the particle size of the positive electrode active material was smaller than 0.1 μm, the cycle characteristics slightly deteriorated as compared with the case where the particle size was 0.5 μm or less and 0.1 μm or more. From the TEM observation after the cycle test, as in the case where the particle size of the positive electrode active material was 0.5 μm or less and 0.1 μm or more, peeling between the positive electrode active material particles and the solid electrolyte, and cracking in the positive electrode active material and the solid electrolyte could not be confirmed. The reason why the cycle characteristics deteriorate is not necessarily clear, but this is considered to be because when the activity on the surface of the positive electrode active material increases, the side reaction at the interface between the electrode and the electrolyte slightly occurs easily.

TABLE 5

| | Positive electrode layer | | | | Capacitance |
|---|---|---|---|---|---|
| | | | Average particle | Initial | maintenance |
| | | | size of positive | discharge | ratio after |
| | Positive electrode active | | electrode active | capacitance | 10 cycles |
| | material | Solid electrolyte | material (μm) | (mAh/g) | (%) |
| Example 4 | LiCoO₂ (Layered rock salt-type) | Li_{3.2}V_{0.8}Si_{0.2}O₄ (LISICON-type (γ_{II}-Li₃VO₄-type)) | 0.22 | 134 | 99.0% ⊙⊙ |
| Comparative | LiCoO₂ (Layered rock salt-type) | Li_{3.2}V_{0.8}Si_{0.2}O₄ (LISICON-type (γ_{II}-Li₃VO₄-type)) | 4.1 | 118 | 73.8% X |
| Example 1 | | | | | |
| Comparative | LiCoO₂ (Layered rock salt-type) | La_{0.56}Li_{0.3}TiO₃ (Perovskite-type) | 0.22 | 67 | 32.6% X |
| Example 4 | | | | | |
| Comparative | LiCoO₂ (Layered rock salt-type) | La_{0.56}Li_{0.3}TiO₃ (Perovskite-type) | 4.1 | 93 | 65.5% X |
| Example 5 | | | | | |
| Comparative | LiCoO₂ (Layered rock salt-type) | Li_{2.2}C_{0.8}B_{0.2}O₃ (Li₂CO₃-type) | 0.22 | 66 | 51.1% X |
| Example 6 | | | | | |
| Comparative | LiCoO₂ (Layered rock salt-type) | Li_{2.2}C_{0.8}B_{0.2}O₃ (Li₂CO₃-type) | 4.1 | 105 | 70.5% X |
| Example 7 | | | | | |
| Comparative | LiFePO₄ (Olivine-type) | Li_{3.2}V_{0.8}Si_{0.2}O₄ (LISICON-type (γ_{II}-Li₃VO₄-type)) | 0.31 | 10 or | — |
| Example 8 | | | | less | |
| Comparative | LiFePO₄ (Olivine-type) | Li_{3.2}V_{0.8}Si_{0.2}O₄ (LISICON-type (γ_{II}-Li₃VO₄-type)) | 4.7 | 10 or | — |
| Example 9 | | | | less | |
| Comparative | Li₃V₂(PO₄)₃ (NASICON-type) | Li_{3.2}V_{0.8}Si_{0.2}O₄ (LISICON-type (γ_{II}-Li₃VO₄-type)) | 0.55 | 10 or | — |
| Example 10 | | | | less | |
| Comparative | Li₃V₂(PO₄)₃ (NASICON-type) | Li_{3.2}V_{0.8}Si_{0.2}O₄ (LISICON-type (γ_{II}-Li₃VO₄-type)) | 5.1 | 10 or | — |
| Example 11 | | | | less | |

### Example 4 and Comparative Examples 1 and 4 to 11

Table 5 showed the initial discharge capacitance and the cycle characteristics when the particle size of LiCoO₂ was changed in a solid-state battery using a solid electrolyte having a type of the crystal structure of the solid electrolyte different from that of the present invention or a solid-state battery using a positive electrode active material having a type of the crystal structure of the positive electrode active material different from that of the present invention in the positive electrode layer.

From Comparative Examples 4 to 7, it was found that when the solid electrolyte having a perovskite-type structure or a Li₂CO₃-type structure was used, the particle size thereof was 4 μm or less, and particularly 1 μm or less, thereby the cycle characteristics deteriorated. From this reason, it is found that due to the change in the crystal structure of the solid electrolyte, the particle size of the positive electrode active material from which excellent cycle characteristics are obtained, differs.

In addition, from Comparative Examples 8 to 11, when the positive electrode active material having an olivine-type structure or the NASICON-type structure is used, the initial discharge capacitance was 10 mAh/g or less and charging and discharging could be hardly carried out in the case of using one having any particle size as the positive electrode active material.

Therefore, it was found for the first time that when the particle size of the positive electrode active material was set to 4 μm or less, it was effective for the solid-state battery including the positive electrode active material having the layered rock salt-type structure and the solid electrolyte having the LISICON-type structure.

TABLE 6

| | Positive electrode layer | | | | Capacitance |
|---|---|---|---|---|---|
| | | | Average particle | Initial | maintenance |
| | | | size of positive | discharge | ratio after |
| | Positive electrode active | | electrode active | capacitance | 10 cycles |
| | material | Solid electrolyte | material (μm) | (mAh/g) | (%) |
| Example 4 | LiCoO₂ (Layered rock salt-type) | Li_{3.2}V_{0.8}Si_{0.2}O₄ (LISICON-type (γ_{II}-Li₃VO₄-type)) | 0.22 | 134 | 99.0% ⊙⊙ |
| Example 12 | LiCoO₂ (Layered rock salt-type) | Li_{3.2}V_{0.8}Ge_{0.2}O₄ (LISICON-type (γ_{II}-Li₃VO₄-type)) | 0.22 | 138 | 99.1% ⊙⊙ |
| Example 13 | LiCoO₂ (Layered rock salt-type) | Li_{3.2}V_{0.8}Ge_{0.2}O₄ (LISICON-type (γ_{II}-Li₃VO₄-type)) | 0.22 | 120 | 99.0% ⊙⊙ |
| Example 14 | LiCoO₂ (Layered rock salt-type) | Li_{3.3}V_{0.7}Si_{0.3}O₄ (LISICON-type (γ_{II}-Li₃VO₄-type)) | 0.22 | 125 | 99.2% ⊙⊙ |
| Example 15 | LiCoO₂ (Layered rock salt-type) | Li_{3.4}V_{0.6}Ge_{0.4}O₄ (LISICON-type (γ_{II}- Li₃VO₄-type)) | 0.22 | 136 | 98.1% ⊙ |
| Example 16 | LiCoO₂ (Layered rock salt-type) | Li_{3.5}V_{0.5}Ge_{0.5}O₄ (LISICON-type (γ_{II}- Li₃VO₄-type)) | 0.22 | 134 | 96.1% ◯ |
| Example 17 | LiCoO₂ (Layered rock salt-type) | Li_{3.5}V_{0.5}Ti_{0.5}O₄ (LISICON-type (γ_{II}- Li₃VO₄-type)) | 0.22 | 123 | 92.1% ◯ |
| Example 18 | LiCoO₂ (Layered rock salt-type) | Li_{3.6}V_{0.4}Ge_{0.6}O₄ (LISICON-type (γ_{II}- Li₃VO₄-type)) | 0.22 | 138 | 95.1% ◯ |
| Example 19 | LiCoO₂ (Layered rock salt-type) | Li_{3.8}V_{0.2}Ge_{0.8}O₄ (LISICON-type (γ_{II}- Li₃VO₄-type)) | 0.22 | 131 | 92.1% ◯ |
| Example 20 | LiCoO₂ (Layered rock salt-type) | Li_{3.8}V_{0.2}Ge_{0.8}O₄ (LISICON-type (γ_{II}-Li₃VO₄-type)) | 0.22 | 110 | 90.2% ◯ |

### Example 4 and 12 to 20

When the particle size of the positive electrode active material used in the positive electrode layer was fixed and the composition of the LISICON-type solid electrolyte was changed, the initial discharge capacitance and the cycle characteristics of the solid-state battery were shown in Table 6.

From Table 6, it can be seen that the change in the composition of the LISICON-type solid electrolyte also causes the capacitance maintenance ratio to change. As to the LISICON-type solid electrolyte, it is found that when the Li amount “3−ax+(5−b)” in the chemical formula (1) or the Li amount “3−ax+(5−c)(1−y)” in the chemical formula (2) is P, P is in the range of 3.1≤P≤3.5 (particularly, in the range of 3.15≤P≤3.45), thereby excellent cycle characteristics of 97% or more are exhibited. Further, it was found that when the Li amount is in the range of 3.15≤P<3.4 (particularly, in the range of 3.2≤P≤3.35), more excellent cycle characteristics of 99% or more were obtained, which was therefore preferable.

TABLE 7

| | Positive electrode layer | | | | Capacitance |
|---|---|---|---|---|---|
| | | | Average particle | Initial | maintenance |
| | | | size of positive | discharge | ratio after |
| | Positive electrode active | | electrode active | capacitance | 10 cycles |
| | material | Solid electrolyte | material (μm) | (mAh/g) | (%) |
| Example 5 | LiCoO₂ (Layered rock salt-type) | Li_{3.2}V_{0.8}Si_{0.2}O₄ (LISICON-type (γ_{II}-Li₃VO₄-type)) | 0.48 | 134 | 99.6% ⊙⊙ |
| Example 21 | Li(Co_{0.33}Ni_{0.33}Mn_{0.33})O₂ (Layered | Li_{3.2}V_{0.8}Si_{0.2}O₄ (LISICON-type (γ_{II}-Li₃VO₄-type)) | 0.35 | 161 | 95.3% ◯ |
| | rock salt-type) | | | | |
| Example 22 | Li(Co_{0.4}Ni_{0.3}Mn_{0.3})O₂ (Layered | Li_{3.2}V_{0.8}Si_{0.2}O₄ (LISICON-type (γ_{II}-Li₃VO₄-type)) | 0.28 | 149 | 96.3% ◯ |
| | rock salt-type) | | | | |
| Example 23 | Li(Co_{0.6}Ni_{0.2}Mn_{0.2})O₂ (Layered | Li_{3.2}V_{0.8}Si_{0.2}O₄ (LISICON-type (γ_{II}-Li₃VO₄-type)) | 0.33 | 148 | 99.8% ⊙⊙ |
| | rock salt-type) | | | | |
| Example 24 | Li(Co_{0.6}Ni_{0.1}Mn_{0.3})O₂ (Layered | Li_{3.2}V_{0.8}Si_{0.2}O₄ (LISICON-type (γ_{II}-Li₃VO₄-type)) | 0.25 | 134 | 99.7% ⊙⊙ |
| | rock salt-type) | | | | |
| Example 25 | Li(Co_{0.8}Ni_{0.1}Mn_{0.1})O₂ (Layered | Li_{3.2}V_{0.8}Si_{0.2}O₄ (LISICON-type (γ_{II}-Li₃VO₄-type)) | 0.35 | 137 | 99.3% ⊙⊙ |
| | rock salt-type) | | | | |
| Example 26 | Li(Co_{0.95}Mg_{0.05})O₂ (Layered rock | Li_{3.2}V_{0.8}Si_{0.2}O₄ (LISICON-type (γ_{II}-Li₃VO₄-type)) | 0.41 | 125 | 99.4% ⊙⊙ |
| | salt-type) | | | | |
| Example 27 | Li(Co_{0.95}Al_{0.05})O₂ (Layered rock | Li_{3.2}V_{0.8}Si_{0.2}O₄ (LISICON-type (γ_{II}-Li₃VO₄-type)) | 0.45 | 115 | 99.5% ⊙⊙ |
| | salt-type) | | | | |
| Example 28 | Li(Ni_{0.8}Co_{0.15}Al_{0.05})O₂ (Layered | Li_{3.2}V_{0.8}Si_{0.2}O₄ (LISICON-type (γ_{II}-Li₃VO₄-type)) | 0.38 | 163 | 93.1% ◯ |
| | rock salt-type) | | | | |

### Examples 5 and 21 to 2

Table 7 showed the initial discharge capacitance and the cycle characteristics when the chemical composition of the positive electrode active material having the layered rock salt-type structure used in the positive electrode layer was changed.

From Table 7, it can be seen that when the positive electrode active material used for the positive electrode layer has the layered rock salt-type structure, the capacitance maintenance ratio after 10 cycles is 90% or more, which is therefore preferable. On the other hand, it can be seen that the cycle characteristics change depending on the Co/Li ratio. From the TEM observation, it was confirmed that in Examples 21 and 28, cracking was generated in the solid electrolyte in the electrode mixture layer after 10 cycles. Among these Examples, it was found that when an active material having a Co/Li ratio of 0.5 or more was used, a higher capacitance maintenance ratio was exhibited.

[Measurement]

(Average Chemical Composition)

The chemical formulas in Tables 4 to 7 indicate the average chemical composition. The average chemical composition means an average value of chemical compositions in the thickness direction of the positive electrode layer, the negative electrode layer, or the solid electrolyte layer.

The average chemical composition was measured by the following method. The average chemical composition was analyzed by breaking the solid-state battery and performing composition analysis by EDX using SEM-EDX (energy dispersive X-ray spectroscopy) in a field of view which fits the whole thickness direction of each layer. In the present invention, composition analysis by EMAX-Evolution manufactured by HORIBA, Ltd. was used for EDX. In particular, it is difficult to quantify Li in the solid electrolyte in the positive electrode layer, and therefore Li was calculated from information of A and B charged before sintering of the chemical formula of Li_{[3-ax+(5-c)(1-y)}]Aₓ) (B_{y}C_{1-y})O₄ and information of x and y obtained by composition analysis of EDX using the above chemical formula.

(Average Particle Size)

The average particle size of 100 arbitrary particles was determined by performing particle analysis using a SEM image or a TEM image of the positive electrode layer and image analysis software (for example, “A image-kun” (manufactured by Asahi Kasei Engineering Corporation)) and calculating the equivalent circle diameter.

The solid-state battery according to an embodiment of the present invention can be used in various fields where the use or storage of the battery is assumed. Although it is merely an example, the solid-state battery according to an embodiment of the present invention can be used in the field of electronics mounting. The solid-state battery according to an embodiment of the present invention can also be used in the fields of electricity, information, and communication in which mobile devices and the like are used (for example, electric and electronic equipment fields or mobile equipment field including small electronic machines such as mobile phones, smart phones, smartwatches, notebook computers and digital cameras, activity meters, arm computers, electronic papers, wearable devices, RFID tags, card-type electronic money, and smartwatches), home and small industrial applications (for example, field of power tools, golf carts, and home, nursing, and industrial robots), large industrial application (for example, field of forklifts, elevators, and harbor cranes), transportation system field (for example, field of hybrid vehicles, electric vehicles, buses, trains, power assist bicycles, electric two-wheeled vehicles, and the like), power system application (for example, field of various types of power generations, road conditioners, smart grids, general household installed-type power storage systems, and the like), medical application (medical equipment fields of earphone hearing aids and the like), pharmaceutical application (field of dosage management systems and the like), IoT field, space and deep sea applications (for example, field of space probes, submersible research vehicles, and the like), and the like.

1. A solid-state battery comprising:
a positive electrode layer that includes a positive electrode active material having a layered rock salt-type structure and including a Li transition metal oxide containing at least one element selected from the group consisting of Co, Ni and Mn, and a solid electrolyte having a LISICON-type structure, and
the positive electrode active material has an average particle size of 4 μm or less.

2. The solid-state battery according to claim 1, wherein the average particle size of the positive electrode active material is 0.01 μm to 4 μm.

3. The solid-state battery according to claim 1, wherein the average particle size of the positive electrode active material is 2.5 μm or less.

4. The solid-state battery according to claim 1, wherein the average particle size of the positive electrode active material is 0.04 μm to 2.5 μm.

5. The solid-state battery according to claim 1, wherein the average particle size of the positive electrode active material is 0.07 μm to 1 μm.

6. The solid-state battery according to claim 1, wherein the average particle size of the positive electrode active material is 0.1 μm to 0.5 μm.

7. The solid-state battery according to claim 1, wherein the positive electrode active material is a material exhibits a volume expansion during charging as compared to a volume thereof before charging.

8. The solid-state battery according to claim 7, wherein the positive electrode active material has a Co/Li ratio of 0.5 or more.

9. The solid-state battery according to claim 7, wherein the positive electrode active material has a Co/Li ratio of 0.5 to 2.0.

10. The solid-state battery according to claim 7, wherein the positive electrode active material has a Co/Li ratio of 0.8 to 1.5.

11. The solid-state battery according to claim 1, wherein the Li transition metal oxide contains at least Co.

12. The solid-state battery according to claim 1, wherein the solid electrolyte has an average chemical composition represented by chemical formula (1):
(Li_{[3-ax+(5-b)}]Aₓ)BO₄ (1)
wherein
A is one or more elements selected from the group consisting of Na, K, Mg, Ca, Al, Ga, Zn, Fe, Cr, and Co;
B is one or more elements selected from the group consisting of Zn, Al, Ga, Si, Ge, Sn, V, P, As, Ti, Mo, W, Fe, Cr, and Co;
0≤x≤1.0;
a is an average valence of A;
b is an average valence of B; and
3.0≤[3−ax+(5−b)]≤4.0.

13. The solid-state battery according to claim 12, wherein:
0≤x≤0.2; and
3.1≤[3−ax+(5−b)]<3.5.

14. The solid-state battery according to claim 1, wherein the solid electrolyte has an average chemical composition represented by chemical formula (2):)
(Li_{[3-ax+(5-c)(1-y)}]Aₓ)(B_{y}CC_{1-y})O₄ (2)
wherein
A is one or more elements selected from the group consisting of Na, K, Mg, Ca, Al, Ga, Zn, Fe, Cr, and Co;
B is one or more elements selected from the group consisting of V and P;
C is one or more elements selected from the group consisting of Zn, Al, Ga, Si, Ge, Sn, As, Ti, Mo, W, Fe, Cr, and Co;
0≤x≤1.0;
0.5<y<1.0;
a is an average valence of A;
c is an average valence of B; and
3.0≤[3−ax+(5−c)(1−y)]≤4.0.

15. The solid-state battery according to claim 14, wherein:
0≤x≤0.2;
0.55≤y≤0.95; and
3.1≤[3−ax+(5−b)]<3.5.

16. The solid-state battery according to claim 14, wherein
the positive electrode active material has an average particle size of 0.07 μm to 1 μm, and
the positive electrode active material has a Co/Li ratio of 0.5 or more.

17. The solid-state battery according to claim 1, wherein
the positive electrode layer further includes a sintering additive, and
the sintering additive is a compound having a chemical composition containing Li, B, and 0, and having a molar ratio of Li to B (Li/B) of 2.0 or more.

18. The solid-state battery according to claim 1, wherein
the solid-state battery further includes a solid electrolyte layer, and
the solid electrolyte layer includes at least a solid electrolyte having a garnet-type structure or a LISICON-type structure.

19. The solid-state battery according to claim 1, wherein
the solid-state battery further includes a negative electrode layer and a solid electrolyte layer,
the positive electrode layer and the negative electrode layer are laminated with the solid electrolyte layer interposed therebetween, and
the solid electrolyte layer, the positive electrode layer, and the negative electrode layer are an integrally sintered body.
